(19) United States
(12) Patent Application Publication
(10) Pub. No.: US 2014/0198263 A1
(43) Pub. Date: Jul. 17, 2014

(54) LIQUID CRYSTAL DISPLAY (LCD) TV BACKBOARD MODULE, LCD TV BACKLIGHT MODULE STRUCTURE AND LCD TV STRUCTURE

(71) Applicant: GLOBAL LIGHTING TECHNOLOGIES (TAIWAN) INC., Taoyuan Hsien (TW)

(72) Inventors: Chuan Jie Hsu, Taoyuan Hsien (TW); Hsin Hong Chen, Taoyuan Hsien (TW); Yan Lin Pan, Taoyuan Hsien (TW); John Araki, Taoyuan Hsien (TW); Chih Chieh Kao, Taoyuan Hsien (TW)

(73) Assignee: Global Lighting Technologies (Taiwan) Inc., Taoyuan Hsien (TW)

(21) Appl. No.: 13/740,163

(22) Filed: Jan. 12, 2013

(51) Int. Cl. H04N 5/64

(52) U.S. Cl. CPC H04N 5/64
USPC 348/794

(57) ABSTRACT

An LCD backboard module includes a backboard, at least one speaker installed on the backboard, and a main body. The main body is combined with the backboard, and includes a motherboard and a back cover, wherein the motherboard is placed inside the back cover.

### BACKGROUND OF THE INVENTION

1. Field of the Invention

The present invention relates to a backboard module, a backlight module structure and a TV structure. More particularly, the present invention relates to an LCD TV backboard module, an LCD TV backlight module structure and an LCD TV structure.

2. The Prior Arts

LCD display is a full-color display device developed with liquid crystal technology. The LCD display has been used in a wide range of electronic products including laptops, monitors and flat-screen TVs due to its advantages of low energy consumption, low radiation, small size and light weight. In addition, the size of the LCD display can be quite flexible.

The difference between the LCD display TV and the conventional CRT TV resides in that, the liquid crystal of LCD TV is not lit like the cathode ray tube does. Therefore, a backlight module is required in the LCD TV.

As the technology develops, the thickness of the LCD TV has become thinner and thinner, yet the developers are still researching and developing new ways to make the LCD TVs even thinner than they are right now. Unlike the computer monitors, LCD TVs usually have built-in speaker modules, thereby increasing the thickness of the LCD TV.

In the conventional configuration of LCD TV backlight module, a plastic casing is utilized to connect the TV and speaker, which increases the thickness of the LCD TV correspondingly. Therefore, minimizing the thickness of the LCD TV with built-in speakers is an objective goal of those who skilled in the art.

Due to the above reasons, the objective of the present invention is to provide an LCD TV module structure, in which the speaker is connected directly to the backboard of the LCD TV, thereby reducing the overall thickness of the LCD TV effectively.

### SUMMARY OF THE INVENTION

An objective of the present invention is to provide a backboard module, especially an LCD TV backboard module.

Another objective of the present invention is to provide a backlight module structure, especially an LCD TV backlight module structure.

Yet another objective of the present invention is to provide a TV structure, especially an LCD TV structure.

In order to fulfill the above described objective, the LCD TV backboard module provided by the present invention includes: a backboard, at least one speaker installed on the backboard and a main body. The main body is combined with the backboard, and further includes a motherboard and a back cover; wherein the motherboard is placed in the back cover.

In order to fulfill another above described objective, the LCD TV backlight module structure provided by the present invention includes: a back light module and an LCD TV backboard module. The LCD TV backboard module further includes a backboard, at least one speaker installed on the backboard and a main body. The main body is combined with the backboard, and further includes a motherboard and a back cover; wherein the motherboard is placed in the back cover.

In order to fulfill another above described objective, the LCD TV structure provided by the present invention includes: a mounting structure, an LCD cell unit, a back light module and an LCD TV backboard module. The LCD TV backboard module further includes a backboard, at least one speaker installed on the backboard and a main body. The main body is combined with the backboard, and further includes a motherboard and a back cover; wherein the motherboard is placed in the back cover.

### BRIEF DESCRIPTION OF THE DRAWINGS

FIG. 1 is an exploded view showing a preferred embodiment of the LCD TV backboard module of the present invention;

FIG. 2 is a side view showing a preferred embodiment of the LCD TV backboard module of the present invention;

FIG. 3 is an exploded and perspective view showing a preferred embodiment of the LCD TV backlight module structure of the present invention;

FIG. 4 is an exploded and perspective view showing a preferred embodiment of the LCD TV structure of the present invention; and

FIG. 5 is an exploded and perspective view showing another embodiment of the LCD TV structure of the present invention.

### DETAILED DESCRIPTION OF THE PREFERRED EMBODIMENTS

The present invention will be apparent to those skilled in the art by reading the following detailed description of preferred embodiments thereof, with reference to the attached drawings. For the matter of clearance and convenience, the ratios of the elements in the drawings are not drawn according to the actual ratio. In addition, the elements which are not directly related to the present invention are emitted in the drawings and description.

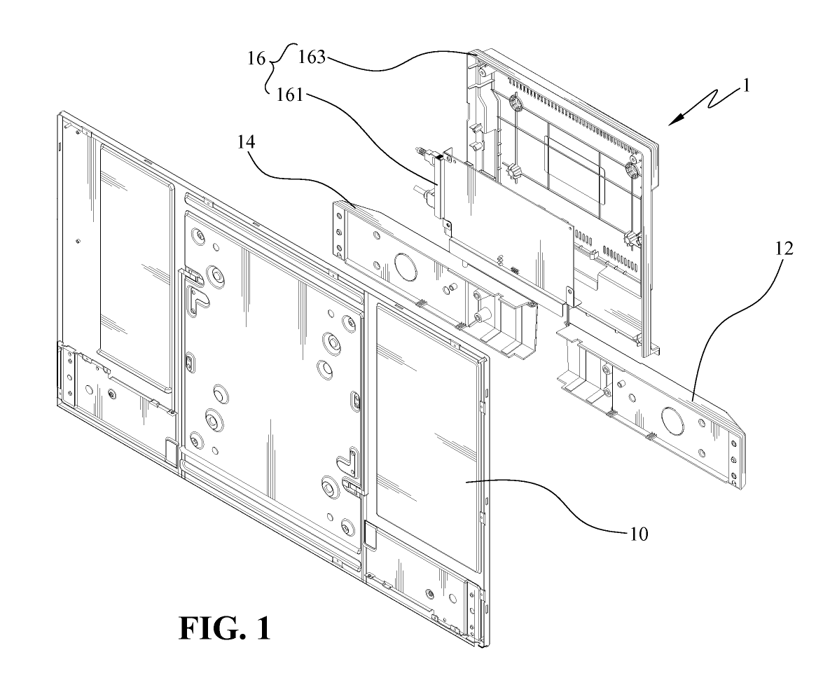

FIG. 1 shows an exploded and perspective view of the LCD TV backboard module 1 of the present invention. As shown in FIG. 1, the LCD TV backboard module 1 includes a backboard 10, two speakers 12 and 14, and a main body 16.

The backboard 10 is manufactured from metal, plastics or any other suitable materials. The backboard 10 is installed at one side of the backlight module to support and strengthen the backlight module.

The speakers 12 and 14 are installed at the left and right side of the backboard 10 respectively. In this preferred embodiment, the speakers 12 and 14 are installed by tightening screws, or inserting the insert rods.

Note that two speakers 12 and 14 are used in this preferred embodiment. However, the number of the speakers used in the LCD TV backboard module 1 is not limited in the present invention, and multiple speakers can be used. When designing the LCD TV backboard module 1 with one or more than two speakers, the speakers can be installed onto the backboard 10 with screws or insert rods.

The main body 16 further includes a motherboard 161 and a back cover 163, where the motherboard 161 is placed inside the back cover 163. Similar to the speakers 12 and 14, the main body 16 is combined with the back cover 10 via screws or insert rods.

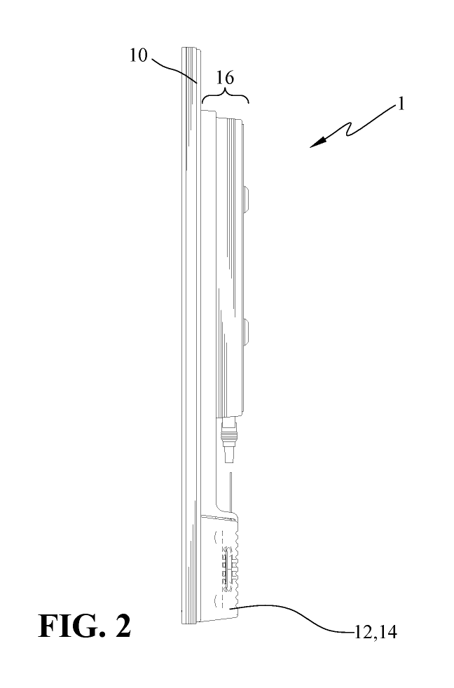

FIG. 2 is a side view showing a preferred embodiment of the LCD TV backboard module of the present invention. The backboard 10, speakers 12 and 14 and the main body 16 are shown in FIG. 2.

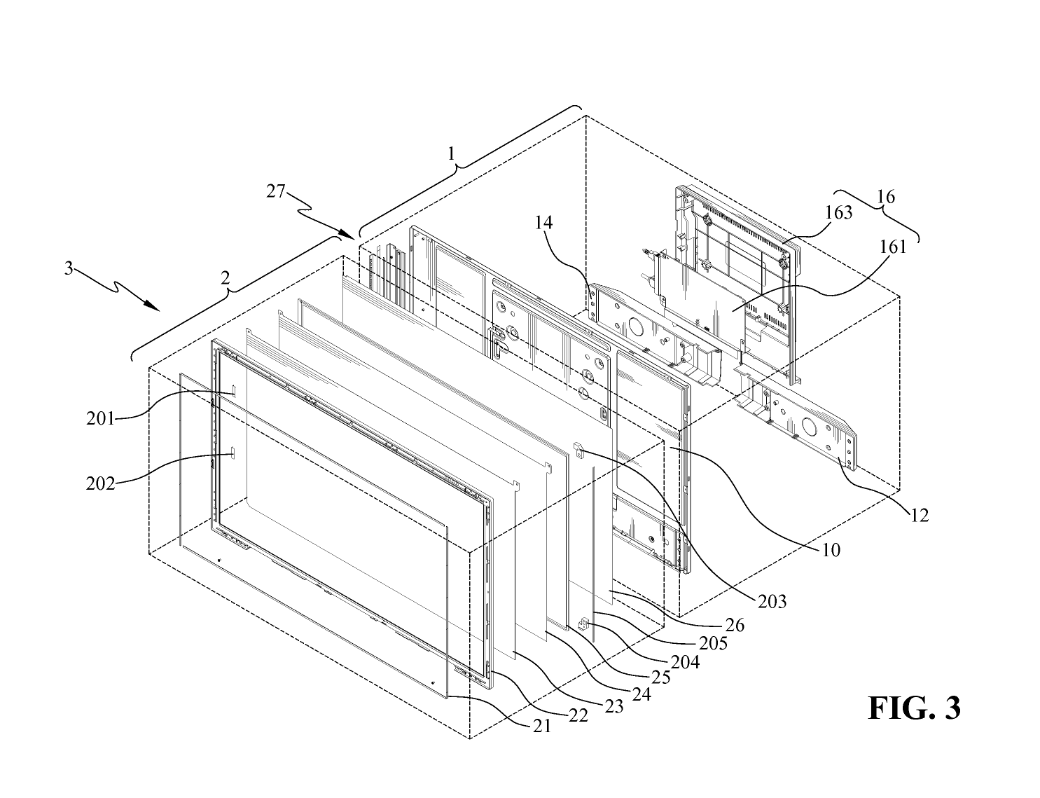

FIG. 3 is an exploded and perspective view showing a preferred embodiment of the LCD TV backlight module structure of the present invention. As shown in FIG. 3, the LCD TV backlight module 3 includes a backlight module 2 and an LCD TV backboard module 1.

The LCD TV backboard module 1 includes a backboard 10, two speakers 12 and 14, and a main body 16. The backboard 10 is manufactured from metal, plastics or any other suitable materials. The backboard 10 is installed at one side of the backlight module to support and strengthen the backlight module.

The speakers 12 and 14 are installed at the left and right side of the backboard 10 respectively. In this preferred embodiment, the speakers 12 and 14 are installed by tightening screws, or inserting the insert rods.

Note that two speakers 12 and 14 are used in this preferred embodiment. However, the number of the speakers used in the LCD TV backboard module 1 is not limited in the present invention, and multiple speakers can be used. When designing the LCD TV backboard module 1 with one or more than two speakers, the speakers can be installed onto the backboard 10 with screws or insert rods.

The main body 16 further includes a motherboard 161 and a back cover 163, where the motherboard 161 is placed inside the back cover 163. Similar to the speakers 12 and 14, the main body 16 is combined with the back cover 10 via screws or insert rods.

The backlight module 2 includes a tape 21, a frame 22, a first optical film 23, a second optical film 24, a light conducting plate 25, a reflection film 26 and circuit board components 27 (including heat radiation elements and circuit board). Light-shielding tape (to avoid the light leakage), insulation tape, double-sided tape (to secure the components at corresponding location), conducting tape for grounding the circuit components or cushion material are used between or among the above described components.

Some of the components shown in FIG. 3, includes insulation stickers 201 and 202, rubber cushion pads 203 and 204, and the side reflection film 205. The rubber cushion pads 203 and 204 serves as the cushion for loading, and the side reflection film 205 increases the light utilization rate of the light source.

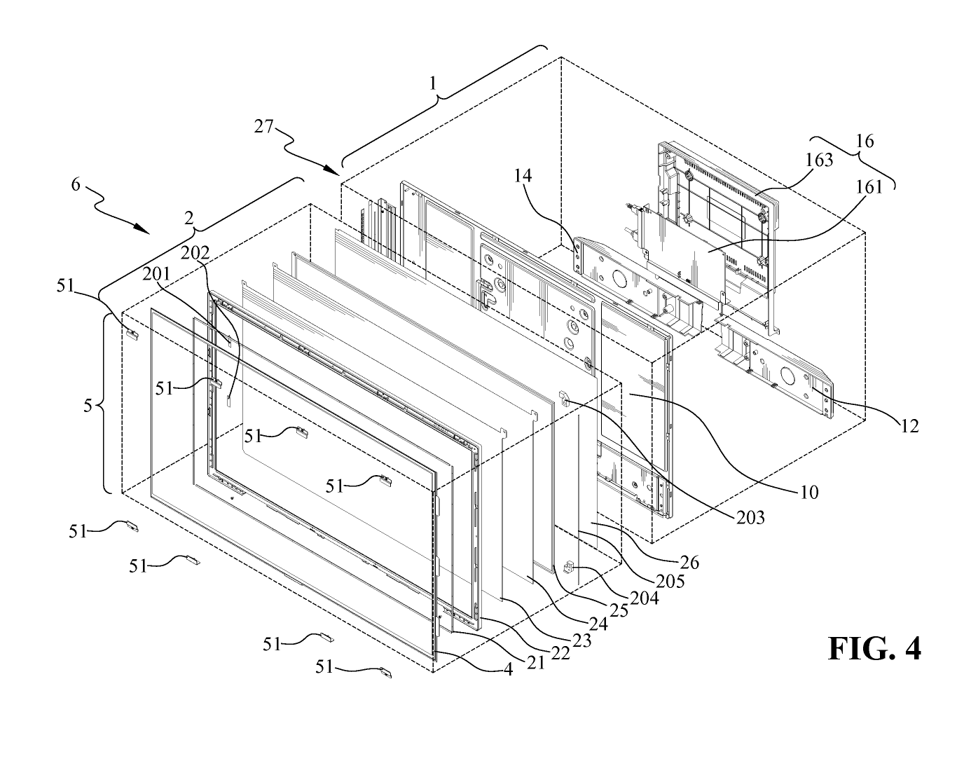

FIG. 4 is an exploded and perspective view showing a preferred embodiment of the LCD TV structure 6 of the present invention. As shown in FIG. 4, the LCD TV structure 6 includes a mounting structure 5, an LCD cell 4, a backlight module 2 and an LCD TV backboard module 1.

In this preferred embodiment, the mounting structure 5 is a Z-shaped clamp 51, which is used to mount the LCD display cell 4.

The LCD TV backboard module 1 includes a backboard 10, two speakers 12 and 14, and a main body 16. The backboard 10 is manufactured from metal, plastics or any other suitable materials. The backboard 10 is installed at a side of the backlight module to support and strengthen the backlight module.

The speakers 12 and 14 are installed at the left and right side of the backboard 10 respectively. In this preferred embodiment, the speakers 12 and 14 are installed by tightening screws, or inserting the insert rods.

Note that two speakers 12 and 14 are used in this preferred embodiment. However, the number of the speakers used in the LCD TV backboard module 1 is not limited in the present invention, and multiple speakers can be used. When designing the LCD TV backboard module 1 with one or more than two speakers, the speakers can be installed onto the backboard 10 with screws or insert rods.

The main body 16 further includes a motherboard 161 and a back cover 163, where the motherboard 161 is placed inside the back cover 163. Similar to the speakers 12 and 14, the main body 16 is combined with the back cover 10 via screws or insert rods.

The backlight module 2 includes a tape 21, a frame 22, a first optical film 23, a second optical film 24, a light conducting plate 25, a reflection film 26 and circuit board components 27 (including heat radiation elements and circuit board). Light-shielding tape (to avoid the light leakage), insulation tape, double-sided tape (to secure the components at corresponding location), conducting tape for grounding the circuit components or cushion material are used between or among the above described components.

Some of the components shown in FIG. 4, includes insulation stickers 201 and 202, rubber cushion pads 203 and 204, and the side reflection film 205. The rubber cushion pads 203 and 204 serves as the cushion for loading, and the side reflection film 205 increases the light utilization rate of the light source.

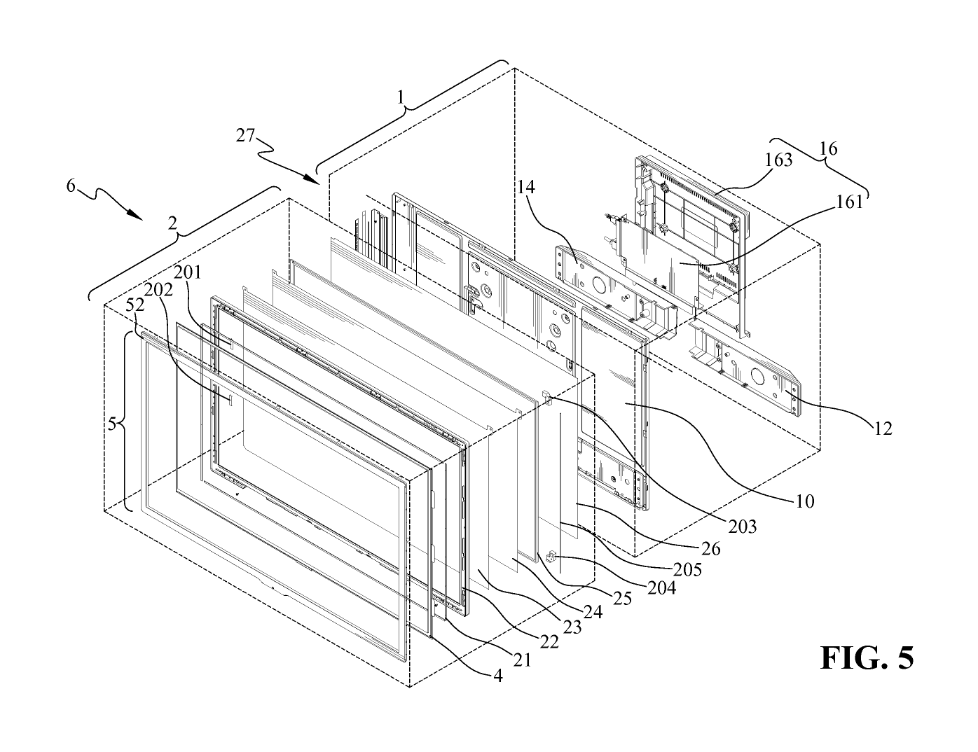

FIG. 5 is an exploded and perspective view showing another embodiment of the LCD TV structure 6 of the present invention. As shown in FIG. 5, the LCD TV structure 6 includes a mounting structure 5, an LCD cell 4, a backlight module 2 and an LCD TV backboard module 1.

In this preferred embodiment, the mounting structure 5 is a mounting frame 52, which is used to mount the LCD display cell 4.

The LCD TV backboard module 1 includes a backboard 10, speakers 12 and 14, and a main body 16. The backboard 10 is manufactured from metal, plastics or any other suitable materials. The backboard 10 is installed at one side of the backlight module to support and strengthen the backlight module.

The speakers 12 and 14 are installed at the left and right side of the backboard 10 respectively. In this preferred embodiment, the speakers 12 and 14 are installed by tightening screws, or inserting the insert rods.

Note that two speakers 12 and 14 are used in this preferred embodiment. However, the number of the speakers used in the LCD TV backboard module 1 is not limited in the present invention, and multiple speakers can be used. When designing the LCD TV backboard module 1 with one or more than two speakers, the speakers are installed onto the backboard 10 with screws or insert rods.

The main body 16 further includes a motherboard 161 and a back cover 163, where the motherboard 161 is placed inside the back cover 163. Similar to the speakers 12 and 14, the main body 16 is combined with the back cover 10 via screws or insert rods.

The backlight module 2 includes a tape 21, a frame 22, a first optical film 23, a second optical film 24, a light conducting plate 25, a reflection film 26 and circuit board components 27 (including heat radiation elements and circuit board). Light-shielding tape (to avoid the light leakage), insulation tape, double-sided tape (to secure the components at corresponding location), conducting tape for grounding the circuit components or cushion material are used between or among the above described components.

Some of the components shown in FIG. 5, includes insulation stickers 201 and 202, rubber cushion pads 203 and 204, and the side reflection film 205. The rubber cushion pads 203 and 204 serves as the cushion for loading, and the side reflection film 205 increases the light utilization rate of the light source.

With the LCD TV backboard module 1, the LCD TV backlight module structure 3 and the LCD TV structure 6 described above, the speakers 12 and 14 are directly installed on the backboard 10 to form a modulized structure with LCD TV backboard module 1, the LCD TV backlight module structure 3 and the LCD TV structure 6. Instead of using the plastic casing as a connector, the modular structure provided by the present invention can effectively reduce the thickness of the LCD TV.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A liquid crystal display (LCD) TV backboard module, comprising:
a backboard;
at least one speaker installed on said backboard; and
a main body combined with said backboard, including a motherboard and a back cover, wherein said motherboard is placed in said back cover.

2. The LCD TV backboard module as claimed in claim 1, wherein said speaker is installed on said backboard via a plurality of screws.

3. The LCD TV backboard module as claimed in claim 1, wherein said speaker is installed on said backboard via a plurality of insert rods.

4. The LCD TV backboard module as claimed in claim 1, wherein said main body is combined with said backboard via a plurality of screws or a plurality of insert rods.

5. The LCD TV backboard module as claimed in claim 1, wherein said LCD TV backboard module includes two of said speakers, which are formed on the left and right side of said backboard respectively.

6. A liquid crystal display (LCD) TV backlight module structure, comprising:
a backlight module; and
an LCD TV backboard module including:
a backboard,
at least one speaker installed on said backboard, and
a main body combined with said backboard including a motherboard and a back cover, wherein said motherboard is placed in said back cover.

7. The LCD TV backboard module structure as claimed in claim 6, wherein said speaker of said LCD backboard module is installed on said backboard via a plurality of screws.

8. The LCD TV backboard module structure as claimed in claim 6, wherein said speaker of said LCD backboard module is installed on said backboard via a plurality of insert rods.

9. The LCD TV backboard module structure as claimed in claim 6, wherein said main body is combined with said backboard via a plurality of screws or a plurality of insert rods.

10. The LCD TV backboard module structure as claimed in claim 6, wherein said LCD TV backboard module includes two of said speakers, which are formed on the left and right side of said backboard respectively.

11. A liquid crystal display (LCD) TV structure, comprising:
a mounting structure;
an LCD cell unit;
a backlight module; and
an LCD TV backboard module, including:
a backboard,
at least one speaker installed on said backboard, and
a main body combined with said backboard, including a motherboard and a back cover, wherein said motherboard is placed in said back cover.

12. The LCD TV structure as claimed in claim 11, wherein said mounting structure is a Z-shaped clamp.

13. The LCD TV structure as claimed in claim 11, wherein said mounting structure is a mounting frame.

14. The LCD TV structure as claimed in claim 11, wherein said speaker of said LCD backboard module is installed on said backboard via a plurality of screws.

15. The LCD TV structure as claimed in claim 11, wherein said speaker of said LCD backboard module is installed on said backboard via a plurality of insert rods.

16. The LCD TV backboard module structure as claimed in claim 6, wherein said main body is combined with said backboard via a plurality of screws or a plurality of insert rods.

17. The LCD TV structure as claimed in claim 11, wherein said LCD TV backboard module includes two of said speakers, which are formed on the left and right side of said backboard respectively.
